(19) United States
(12) Patent Application Publication
(10) Pub. No.: US 2013/0047726 A1
(43) Pub. Date: Feb. 28, 2013

(54) ANGULAR RATE SENSOR WITH DIFFERENT GAP SIZES

(71) Applicants: Yizhen Lin, Gilbert, AZ (US); Andrew C. McNeil, Chandler, AZ (US)

(72) Inventors: Yizhen Lin, Gilbert, AZ (US); Andrew C. McNeil, Chandler, AZ (US)

(73) Assignee: FREESCALE SEMICONDUCTOR, INC., Austin, TX (US)

(21) Appl. No.: 13/219,071

(22) Filed: Aug. 26, 2011

(51) Int. Cl. G01P 15/08

(52) U.S. Cl. 73/504.12

(57) ABSTRACT

An angular rate sensor (20) includes conductive plates (24, 26, 28, 30) mounted on a substrate (22), and a structure (34) coupled to the substrate (22). The structure (34) includes a drive mass (36) and a sense mass (40) suspended above the plates (24, 26, 28, 30). The sense mass (40) includes regions (50, 52) separated by a sense axis of rotation (48). Each of the regions (50, 52) has an outer surface (56) and an inner surface (54). An inner gap (68) exists between the inner surface (54) and plates (24, 26, 28). An outer gap (70) exists between the outer surface (56) and the plate (30). The outer gap (70) is larger than the inner gap (68). Plates (24, 26, 28) may be electrodes for force feedback, frequency tuning, and/or quadrature compensation. Plates (30) may be electrodes for sensing angular velocity.

### TECHNICAL FIELD OF THE INVENTION

The present invention relates generally to microelectromechanical systems (MEMS) devices. More specifically, the present invention relates to a MEMS device that includes an angular rate sensor having a teeter-totter structure with different gap sizes.

### BACKGROUND OF THE INVENTION

Microelectromechanical systems (MEMS) technology has achieved wide popularity in recent years, as it provides a way to make very small mechanical structures and integrate these structures with electrical devices on a single substrate using conventional batch semiconductor processing techniques. One common application of MEMS is the design and manufacture of sensor devices. Microelectromechanical Systems (MEMS) devices are widely used in applications such as automotive, inertial guidance systems, household appliances, game devices, protection systems for a variety of devices, and many other industrial, scientific, and engineering systems. One example of a MEMS sensor is a MEMS angular rate sensor. Alternatively referred to as a “gyroscope”, “gyrometer,” “gyroscope sensor,” or “yaw rate sensor,” an angular rate sensor senses angular speed or velocity around one or more axes.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a top view of an angular rate sensor in accordance with an embodiment;

FIG. 2 shows a side view of the angular rate sensor of FIG. 1 along section line 2-2 of FIG. 1;

FIG. 3 shows another side view of the angular rate sensor of FIG. 1;

FIG. 4 shows a chart of equations obtained in accordance with conductive plates of the angular rate sensor and their respective distances to a sense axis;

FIG. 5 shows a top view of an angular rate sensor in accordance with another embodiment;

FIG. 6 shows a side view of a portion of the angular rate sensor along section line 6-6 of FIG. 5; and

FIG. 7 shows a top view of an angular rate sensor in accordance with yet another embodiment.

### DETAILED DESCRIPTION

Embodiments disclosed herein entail microelectromechanical (MEMS) devices in the form of angular rate sensors having teeter-totter type sense masses. In particular, an angular rate sensor has air gaps of different heights between the sense mass and the underlying substrate in order to increase the sensitivity of the angular rate sensor, the force feedback capability, and the frequency tuning range. Additionally, the angular rate sensor can include motion stops arranged to preserve the functional life of the angular rate sensor by preventing collision-related damage to the active electrode areas.

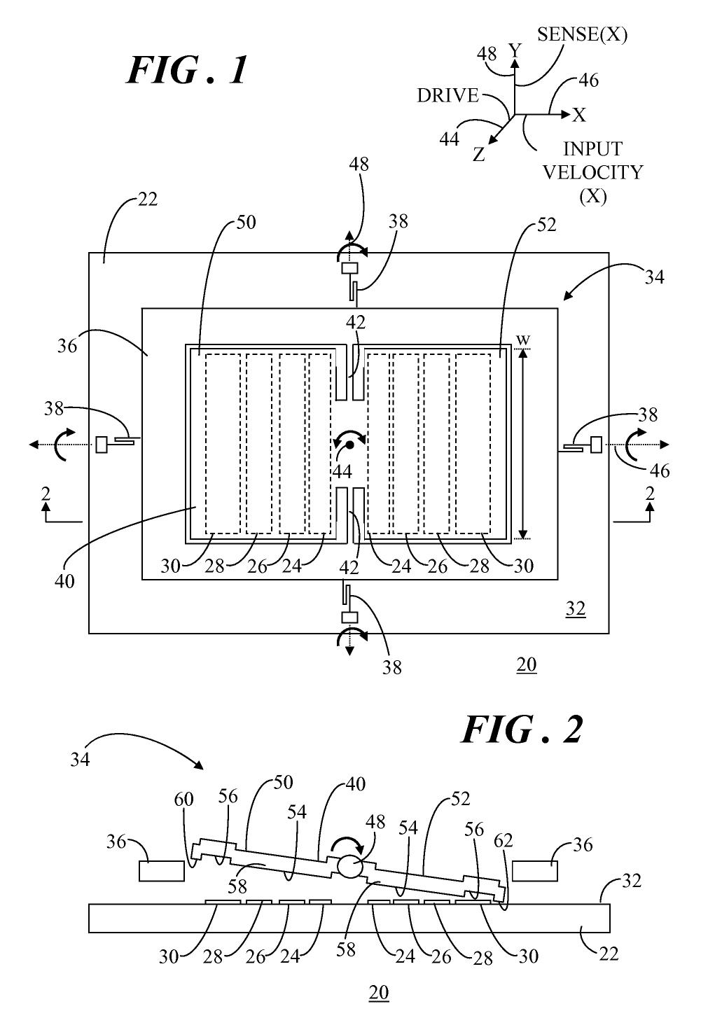

Referring to FIGS. 1-2, FIG. 1 shows a top view of an angular rate sensor 20 in accordance with an embodiment, and FIG. 2 shows a side view of angular rate sensor 20 along section lines 2-2 in FIG. 1. Angular rate sensor 20 includes a substrate 22, and conductive plates 24, 26, 28, and 30, i.e., electrodes, fixedly mounted or otherwise formed on a surface 32 of substrate 22. A structure 34 is coupled to and suspended above surface 32 of substrate 22. Structure 34 overlies conductive plates 24, 26, 28, and 30. Consequently, conductive plates 24, 26, 28, and 30 are obscured in the top view of sensor 20, and are thus represented in dashed line form in FIG. 1. Structure 34 includes a drive mass 36 flexurally attached with flexible support elements 38, e.g. springs, to surface 32 of substrate 22. Structure 34 further includes a sense mass 40 residing in an opening extending through drive mass 36. Sense mass 40 is attached to drive mass 36 with flexible support elements, i.e., torsion flexures 42.

To operate angular rate sensor 20, a drive system (not shown) in communication with drive mass 36 enables mechanical oscillation of drive mass 36 in a plane parallel to surface 32 of substrate 22 about a first axis of rotation, referred to herein as a drive axis 44. As such, drive axis 44 is perpendicular to surface 32. In this example, drive axis 44 is a Z-axis in a three-dimensional coordinate system. Sense mass 40 oscillates about drive axis 44 together with drive mass 36 due to the high stiffness of torsion flexures 42 to this motion. The oscillatory drive motion may be kept constant to maintain constant sensitivity of angular rate sensor 20. Additionally or alternatively, the frequency of oscillation can be locked to the mechanical resonance of drive mass 36 to minimize drive power.

Once sense mass 40 is put into oscillatory motion about drive axis 44, it is capable of detecting an angular rate, i.e., angular velocity, induced by angular rate sensor 20 being rotated about a second axis of rotation, referred to herein as an input axis 46. In this example, input axis 46 is the X-axis in a three-dimensional coordinate system. As angular rate sensor 20 experiences an angular velocity about input axis 46, sense mass 40 oscillates about a third axis of rotation, referred to herein as a sense axis 48. In this example, sense axis 48 is the Y-axis in a three-dimensional coordinate system. In particular, a Coriolis acceleration occurs about sense axis 48, which is perpendicular to both drive axis 44 and input axis 46. The Coriolis acceleration results in movement of sense mass 40 about sense axis 48 (i.e., the Y-axis) where the movement has an amplitude that is proportional to the angular rotation rate of sensor 20 about input axis 46, i.e., the X-axis.

In an embodiment, sense axis 48, i.e., the third axis of rotation, divides sense mass 40 into a first region 50 on one side of sense axis 48 and a second region 52 on the opposite side of sense axis 48. Substrate 22 can include a semiconductor layer (not shown) that is covered by one or more insulation layers (not shown). The semiconductor layer is typically a silicon wafer upon which electronics associated with angular rate sensor 20 may, in some cases, also be fabricated using conventional manufacturing technologies. The insulating layer may include glass, silicon dioxide, silicon nitride, or any other compatible material. Conductive plates 24, 26, 28, and 30 may be formed in the semiconductor layer and underlying first and second regions 50 and 52, respectively, of sense mass 40.

Conductors (not shown) can be formed on substrate 22 to provide separate electrical connections to conductive plates 24, 26, 28, and 30 and to sense mass 40. Conductive plates 24, 26, 28, and 30 are formed from a conductive material such as polysilicon, and can be formed at the same time as the respective conductors if the same materials are chosen for such components.

In an embodiment, each of first and second regions 50 and 52 of sense mass 40 has an inner (i.e., first) surface 54 and an outer (i.e., second) surface 56. Outer surface 56 is laterally displaced from sense axis 48 such that inner surface 54 is interposed between sense axis 48 and outer surface 56. Inner surface 54 for each of first and second regions 50 and 52 includes a first corrugation 58, i.e., a downwardly protruding section of sense mass 40, formed thereon.

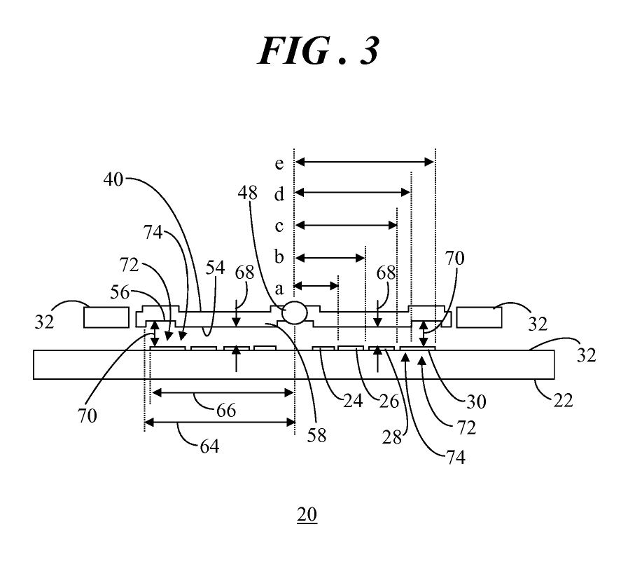

Motion stops 60, 62 also downwardly protrude from outer surface 56 of sense mass 40 toward surface 32 of substrate 22. In an embodiment, each of motion stops 60, 62 is laterally displaced from sense axis 48 by a distance 64 (see FIG. 3) from sense axis 48 that is greater than a distance 66 (see FIG. 3) of an outer edge of conductive plate 30 from sense axis 48. Thus, motion stops 60, 62 are positioned outside of any underlying active conductive area to stop further rotation of sense mass 40 in response to excessive angular velocity. That is, motion stops 60, 62 will come into contact with surface 32 of substrate 22 in response to excessive angular velocity (exemplified in FIG. 2) and/or other disturbances, so that sense mass 40 will not contact conductive plates 24, 26, 28, and 30 and cause collision-related damage, such as a short.

Corrugations 58 and motion stops 60, 62 can be formed from the same conductive material as the remainder of sense mass 40. During an exemplary processing method, corrugations 58 and motion stops 60, 62 can be formed by conventional layered deposition, patterning, and etching operations of one or more sacrificial oxide layers, one or more structural polysilicon layers, and the like. For example, a sacrificial oxide layer deposited overlying substrate 22 may be selectively etched to leave indentations in the sacrificial layer. A structural layer may then be deposited over the sacrificial layer, thus filling in the indentations. The structural layer can then be suitably patterned and etched to form sense mass 40 having the downwardly protruding corrugations 58 and motion stops 60, 62.

FIG. 3 shows another side view of angular rate sensor 20 in which sense mass 40 is not rotating about sense axis 48. For each of first and second regions 50 and 52, an inner (i.e., first) gap 68 exists between first corrugation 58 and opposing conductive plates 24, 26, and 28. Likewise, an outer (i.e., second) gap 70 exists between outer surface 56 of sense mass 40 and at least a portion of conductive plate 30. In an illustrated embodiment, outer gap 70 exists between outer surface 56 of sense mass 40 and a first portion 72 of conductive plate 30 and inner gap 68 exists between first corrugation 58 and a second portion 74 of conductive plate 30.

Corrugations 58 in each of first and second regions 50 and 52 of sense mass 40 produce smaller gaps, i.e., inner gaps 68, in “inboard” areas (closer to sense axis 48). Larger gaps, i.e., outer gaps 70, between sense mass 40 and conductive plates 30 are outwardly disposed (farther from sense axis 48) with respect to the smaller inner gaps 68. The smaller inner gaps 68 bring about a larger proportional change in gap size near sense axis 48 in response to angular velocity when compared with a conventional sense mass having a uniform gap size. Although corrugations 58 are formed in sense mass 40 to produce the smaller inner gaps 68, it should be understood that in alternative embodiments, the underlying structures, for example, conductive plates 24, 26, and 28 could be formed as thicker structures than conductive plates 30. Such a structure would also produce the smaller, inner gaps 68 and the larger, outer gaps 70.

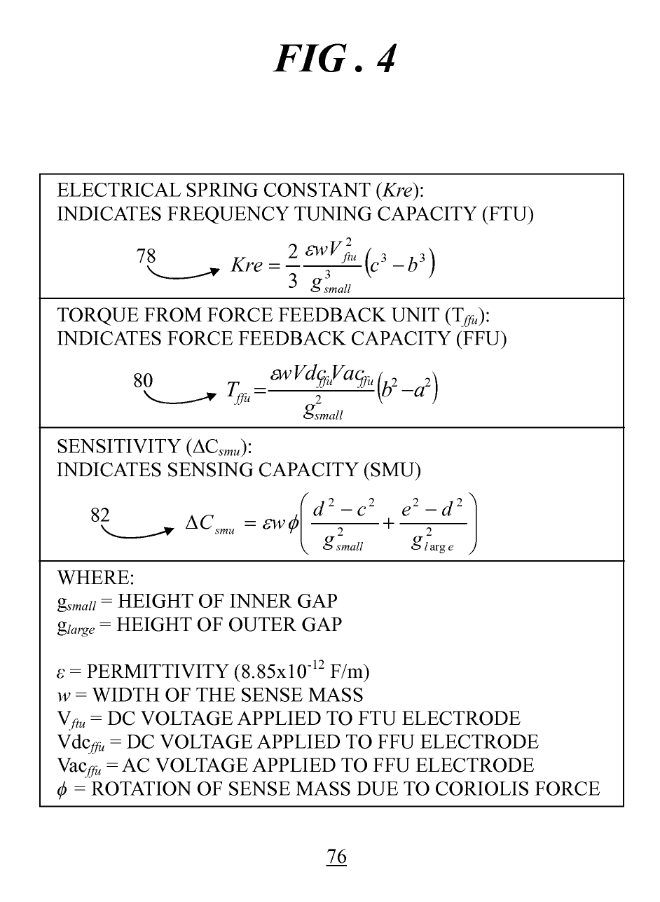

Referring to FIG. 4 in connection with FIG. 3, FIG. 4 shows a chart 76 of equations obtained in accordance with conductive plates 24, 26, 28, and 30 and their respective distances to sense axis 48 (“a” through “e” as shown in FIG. 3) and a width of sense mass 40 (“w” as shown in FIG. 1). In accordance with an embodiment, for each of first and second regions 50 and 52, conductive plates 24 may be quadrature compensation units, conductive plates 26 may be force feedback units, conductive plates 28 may be frequency tuning units, and conductive plates 30 may be sense measure units. Thus, quadrature compensation units 24, force feedback units 26, and frequency tuning units 28 are positioned underlying the smaller inner gaps 68, and sense measure units 30 are positioned to have first and second portions 72 and 74 thereof underlying respective ones of the smaller inner gaps 68 and larger outer gaps 70.

Frequency tuning, also referred to as electrostatic tuning, of the resonant modes in microelectromechanical vibratory gyroscopes is typically implemented as a means for compensating for manufacturing aberrations that produce detuned resonances. In an embodiment, dc voltage (V_{ftu}) is applied to frequency tuning units 28 in order to effect an electrical spring constant (Kre) of angular rate sensor 20 that is sensitive to the gap width (to the third power) as exemplified in chart 76 by a first equation 78.

In inertial sensors, such as angular rate sensor 20, force feedback (also known as force-balancing) can be used to raise the linearity, bandwidth, and dynamic range of the sensor. In an embodiment, voltages, i.e., dc and ac voltages (Vdc_{ffu}, and Vac_{ffu}), are applied to force feedback units 26 in order to generate electrostatic force to sense mass 40. This electrostatic force produces torque (T_{ffu}) that is sensitive to the gap width (to the second power) as exemplified in chart 76 by a second equation 80.

An angular rate sensor can sometimes exhibit a quadrature signal, or error, which occurs in vibrating angular rate sensors because of manufacturing flaws that permit the sense mass to oscillate about an axis that is not orthogonal to the sense axis. This creates an oscillation about the sense axis that has a component of the sense mass's vibration acceleration. In some embodiments, an electrostatic force may be applied via quadrature compensation units 24 in opposite phase relation to the quadrature error in order to compensate for, or otherwise null, the quadrature signal.

An output signal, i.e., the angular velocity of angular rate sensor 20 about input axis 46 (FIG. 1), is detected via sense measure units 30. Like force feedback and frequency tuning, the sensitivity of sense measure units 30 is also sensitive to the gap width (to the second power) as exemplified in chart 76 by a third equation 82. In accordance with an embodiment, first portion 72 of sense measure units 30 underlies the smaller inner gap 68 and second portion 74 of sense measure units 30 underlies the larger outer gap 70. Thus, the sensitivity of angular rate sensor 20, ΔCₛₘᵤ, is a function of the gap width (to the second power) of both inner gap 68 and outer gap 70.

Accordingly, quadrature compensation units 24, force feedback units 26, and frequency tuning units 28 may be positioned underlying the smaller inner gaps 68 to increase or otherwise improve their respective frequency tuning capacity, force feedback capacity, and increase quadrature compensation capacity. And sense measure units 30 may be positioned underlying both inner gaps 68 and outer gaps 70 for improved sensitivity.

Angular rate sensor 20 is illustrated with four different electrode types, i.e., quadrature compensation units 24, force feedback units 26, frequency tuning units 28, and sense measure units 30. However, those skilled in the art will recognize that an angular rate sensor may have a different combination of electrodes. Alternatively or additionally, quadrature compensation units 24, force feedback units 26, frequency tuning units 28 may be positioned underlying the smaller inner gaps 68 in a different order then that which is shown.

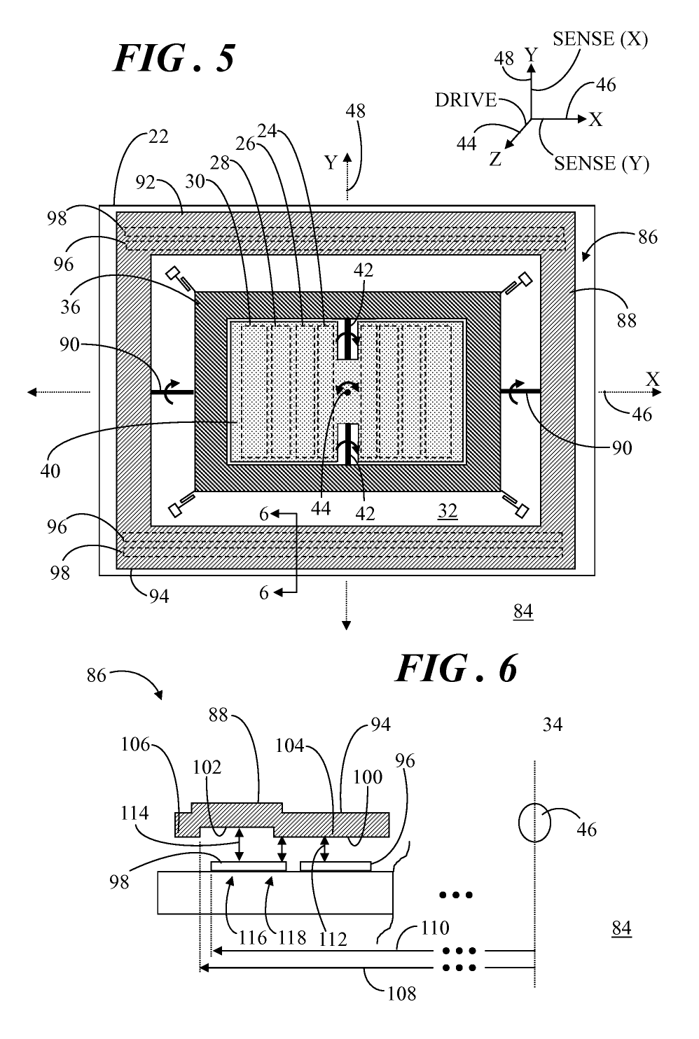

Referring to FIGS. 5 and 6, FIG. 5 shows a top view of an angular rate sensor 84 in accordance with another embodiment, and FIG. 6 shows a side view of a portion of angular rate sensor 84 along section lines 6-6 of FIG. 5. Angular rate sensor 84 is a dual axis sensor configured to sense angular rate about two axes of rotation, and in particular about both X-axis 46 and Y-axis 48. Various elements of angular rate sensor 84 are illustrated with shading or hatching in order to better distinguish them from one another. In accordance with conventional manufacturing techniques, the various elements may be formed concurrently through deposition, patterning, and etching processes, and thus are likely to be manufactured from the same material such as polysilicon.

Angular rate sensor 84 includes elements similar to those described in connection with angular rate sensor 20 (FIG. 1). In particular, angular rate sensor 84 includes substrate 22, and conductive plates 24, 26, 28, and 30 fixedly mounted or otherwise formed on surface 32 of substrate 22. Angular rate sensor 84 further includes a structure 86 coupled to and suspended above surface 32 of substrate 22. Structure 84 includes drive mass 36 flexurally attached to substrate 32, and sense mass 40 residing in an opening extending through drive mass 36. Sense mass 40 is attached to drive mass 36 with torsion flexures 42. Structure 86 further includes another sense mass 88 in the form of a frame surrounding drive mass 36. Sense mass 88 is connected to drive mass 36 by flexible support elements, i.e., torsion flexures 90.

To operate angular rate sensor 84, drive mass 36 is mechanically oscillated in a plane parallel to surface 32 of substrate 22 about drive axis 44. Both sense mass 40 and sense mass 88 oscillate about drive axis 44 together with drive mass 36 due to the high stiffness of respective torsion flexures 42 and 90 to this motion. Once sense masses 40 and 88 are put into oscillatory motion about drive axis 44, sense mass 40 is capable of detecting angular velocity of sensor 84 about X-axis 46, where the angular velocity about X-axis 46 produces a Coriolis acceleration that causes sense mass 40 to oscillate about Y-axis 48 at an amplitude that is proportional to the angular rotation rate of sensor 84 about X-axis 46. By a similar principle, sense mass 88 is capable of detecting angular velocity of sensor 84 about Y-axis 48. That is, as angular rate sensor 84 experiences an angular velocity about Y-axis 48, a Coriolis acceleration occurs about X-axis 46. The Coriolis acceleration results in movement of sense mass 88 about its sense axis, i.e., X-axis 46, at an amplitude that is proportional to the angular rotation rate of sensor 84 about Y-axis 48.

In an embodiment, X-axis 46 divides sense mass 88 into a third region 92 on one side of X-axis 46 and a fourth region 94 on the opposite side of X-axis 46. Conductive plates 96 and 98 are formed on surface 32 of substrate 22 underlying third and fourth regions 92 and 94, respectively. As such, conductive plates 96 and 98 are obscured in the top view of sensor 84, and are thus represented by dashed lines in FIG. 5.

In an embodiment, each of third and fourth regions 92 and 94 has an inner surface 100 and an outer surface 102 (best seen in FIG. 6). Outer surface 102 is laterally displaced from X-axis 46 such that inner surface 100 is interposed between X-axis 46 and outer surface 102. Inner surface 100 for each of third and fourth regions 92 and 94 includes a second corrugation 104, i.e., a downwardly protruding section of sense mass 88, formed thereon.

Motion stops 106 (of which only one is visible in FIG. 6) also downwardly protrude from outer surface 102 of sense mass 88 toward surface 32 of substrate 22. In an embodiment, each motion stop 106 is laterally displaced from X-axis 46 by a distance 108 from X-axis 46 that is greater than a distance 110 of an outer edge of the outermost conductive plate 98 from X-axis 46. Accordingly, motion stops 106 are positioned outside of any underlying active conductive electrode area on surface 32 of substrate 22 to further rotation of sense mass 88 in response to excessive angular velocity. Corrugations 104 and motion stops 106 can be formed from the same conductive material as the remainder of sense mass 88, sense mass 40, and drive mass 36 in accordance with conventional layered deposition, patterning, and etching processes.

For each of third and fourth regions 92 and 94, an inner gap 112 exists between corrugation 104 and opposing conductive plate 96. Likewise, an outer gap 114 exists between outer surface 102 of sense mass 88 and at least a portion of conductive plate 98. In an illustrated embodiment, outer gap 114 exists between outer surface 102 of sense mass 88 and a first portion 116 of conductive plate 98 and inner gap 112 exists between corrugation 104 and a second portion 118 of conductive plate 98.

Corrugations 104 in each of third and fourth regions 92 and 94 of sense mass 88 produce smaller gaps, i.e., inner gaps 112, in “inboard” areas (closer to X-axis 46). Larger gaps, i.e., outer gaps 114, between sense mass 88 and conductive plates 98 are outwardly disposed (farther from X-axis 46) with respect to the smaller inner gaps 112. The smaller inner gaps 112 bring about a larger proportional change in gap size near the sense axis, i.e., X-axis 46 in response to angular velocity when compared with a conventional sense mass having a uniform gap size. Therefore, in an embodiment, conductive plates 96 may be electrodes for a frequency tuning units and conductive plates 98 may be electrodes for sense measure units, as discussed above in connection with FIGS. 3 and 4.

Angular rate sensor 84 is provided with only two pairs of conductive plates 96 and 98 (e.g., frequency tuning units and sense measure units) underlying sense mass 88 for simplicity of illustration. It should be understood, however, that in alternative embodiments, additional electrode types may be provided for force feedback and/or quadrature compensation. In addition, angular rate sensors 20 and 84 are provided with generally rectangular structures 34 and 86 of drive mass and sense mass(es). However, in alternative embodiments, the drive mass and/or sense mass(es) can have different shapes, such as circular rings, disks, and the like.

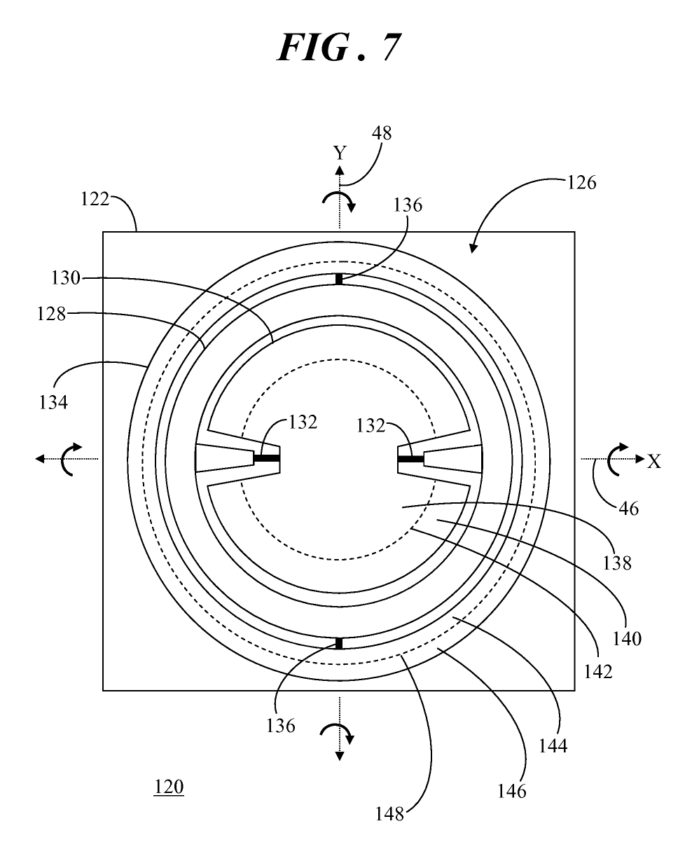

FIG. 7 shows a top view of an angular rate sensor 120 in accordance with yet another embodiment. Angular rate sensor 120 is provided to illustrate an exemplary a dual axis rotary disk type gyroscope. Angular rate sensor 120 includes a substrate 122, and conductive plates (not visible) that can include any variety of sense electrodes, frequency tuning electrodes, force feedback electrodes, and quadrature compensation electrodes fixedly mounted or otherwise formed on a surface 124 of substrate 122. Angular rate sensor 120 further includes a structure 126 coupled to and suspended above surface 124 of substrate 122 by flexures (not visible). Structure 126 includes a ring-type drive mass 128 flexurally attached to substrate 122 and a generally disk-shaped first sense mass 130 residing in an opening extending through drive mass 128. First sense mass 130 is attached to drive mass 128 with flexible support elements, i.e., torsion flexures 132. Structure 126 further includes a second sense mass 134 in the form of a ring-type frame surrounding drive mass 128. Second sense mass 134 is connected to drive mass 128 by flexible support elements, i.e., torsion flexures 136.

To operate angular rate sensor 120, structure 126 that includes drive mass 128, first sense mass 130, and second sense mass 134 is mechanically oscillated in a plane parallel to surface 124 of substrate 122. Once put into oscillatory motion, first sense mass 130 is capable of detecting angular velocity of sensor 120 about Y-axis 48, where the angular velocity about Y-axis 48 produces a Coriolis acceleration that causes first sense mass 130 to oscillate about X-axis 46 at an amplitude that is proportional to the angular rotation rate of sensor 120 about Y-axis 48. By a similar principle, second sense mass 134 is capable of detecting angular velocity of sensor 120 about X-axis 46. That is, as angular rate sensor 120 experiences an angular velocity about X-axis 46, a Coriolis acceleration is produced that causes second sense mass 134 to oscillate about Y-axis 48 at an amplitude that is proportional to the angular rotation rate of sensor 120 about X-axis 46.

In accordance with an embodiment, first sense mass 130 includes an inner (i.e., first) gap region 138 and an outer (i.e., second) gap region 140, delineated by a dashed line 142. Similarly, second sense mass 134 includes an inner (i.e., first) gap region 144 and an outer (i.e., second gap) region 146, also delineated by a dashed line 148. First inner gap regions 138 and 144 are those portions of respective sense masses 130 and 134 that include corrugations (described above) so that the gaps formed between the underlying structures and sense masses 130 and 134 in respective inner gap regions 138 and 144 are smaller than the gaps formed between the underlying structures and sense masses 130 and 134 in respective outer gap regions 140 and 146. In accordance with the principles discussed above, frequency tuning electrodes, force feedback electrodes, and/or quadrature compensation electrodes may underlie inner gap regions 138 and 144 of first and second sense masses 130 and 134, whereas, sense electrodes may underlie outer gap regions 140 and 146 of first and second sense masses 130 and 134.

In summary, embodiments of the invention entail microelectromechanical (MEMS) angular rate sensors having one or more teeter-totter type sense masses. In particular, an angular rate sensor has gaps of different heights between the sense mass and the underlying substrate in order to increase the sensitivity of the angular rate sensor, the force feedback capability, the frequency tuning range, and/or quadrature compensation. Additionally, the angular rate sensor can include motion stops arranged to preserve the functional life of the angular rate sensor by preventing collision-related damage to the active electrode areas.

Although the preferred embodiments of the invention have been illustrated and described in detail, it will be readily apparent to those skilled in the art that various modifications may be made therein without departing from the spirit of the invention or from the scope of the appended claims. That is, it should be appreciated that the exemplary embodiments are only examples, and are not intended to limit the scope, applicability, or configuration of the invention.

What is claimed is:

1. An angular rate sensor comprising:
a substrate having a surface;
conductive plates fixedly mounted on said surface, said conductive plates including a first electrode and a second electrode;
a drive mass flexibly coupled to said substrate surface, said drive mass being configured to move with an oscillatory motion;
a sense mass having first and second regions separated by an axis of rotation, wherein a first gap exists between a first portion of said sense mass and said first electrode, and a second gap exists between a second portion of said sense mass and said second electrode, said second gap being larger than said first gap; and
flexible support elements connecting said sense mass to said drive mass.

2. An angular rate sensor as claimed in claim 1 wherein each of said first and second regions includes a first surface and a second surface laterally displaced from said axis of rotation such that said first surface is interposed between said axis of rotation and said second surface, said first surface having a corrugation formed thereon, said first gap existing between said corrugation and said first electrode, and said second gap existing between said second surface and said second electrode.

3. An angular rate sensor as claimed in claim 1 wherein said axis of rotation is a first axis of rotation oriented parallel to said surface, and said drive mass together with said sense mass are configured to move with said oscillatory motion about a second axis of rotation that is perpendicular to said surface, and said flexible support elements enable said sense mass to oscillate about said first axis of rotation in response to an angular velocity about a third axis of rotation that is perpendicular to each of said first and second axes of rotation.

4. An angular rate sensor as claimed in claim 1 further comprising a third electrode fixedly mounted on said surface of said substrate, and said first gap exists between said first portion of said sense mass and said third electrode.

5. An angular rate sensor as claimed in claim 1 wherein said first electrode is a frequency tuning electrode.

6. An angular rate sensor as claimed in claim 5 wherein said second electrode is a sense electrode.

7. An angular rate sensor as claimed in claim 1 wherein said first electrode is a force feedback electrode.

8. An angular rate sensor as claimed in claim 1 wherein said first electrode is a quadrature compensation electrode.

9. An angular rate sensor as claimed in claim 1 wherein said second electrode is a sense electrode.

10. An angular rate sensor as claimed in claim 9 wherein said second gap exists between said second portion of said sense mass and a first portion of said sense electrode, and said first gap exists between said first portion of said sense mass and a second portion of said sense electrode.

11. An angular rate sensor as claimed in claim 1 wherein said first electrode is a frequency tuning electrode, said second electrode is a sense electrode, and said angular rate sensor further comprises a force feedback electrode fixedly mounted on said surface of said substrate, and said first gap exists between said first portion of said sense mass and said force feedback electrode.

12. An angular rate sensor as claimed in claim 1 wherein said sense mass is a first sense mass, said axis of rotation is a first axis of rotation, said flexible support elements are first flexible support elements, and said angular rate sensor further comprises:
third and fourth electrodes fixedly mounted on said surface of said substrate;
a second sense mass having third and forth regions separated by a second axis of rotation, wherein a third gap exists between a third portion of said second sense mass and said third electrode, and a fourth gap exists between a fourth portion of said second sense mass and said fourth electrode, said fourth gap being larger than said third gap; and
second flexible support elements connecting said second sense mass to said drive mass.

13. An angular rate sensor comprising:
a substrate having a surface;
conductive plates fixedly mounted on said surface, said conductive plates including frequency tuning electrodes and sense electrodes;
a drive mass coupled to said substrate surface, said drive mass being configured to move with an oscillatory motion;
a sense mass having first and second regions separated by an axis of rotation, each of said first and second regions having a first gap existing between a first portion of said sense mass and one of said frequency tuning electrodes, and having a second gap existing between a second portion of said sense mass and one of said sense electrodes, said second gap being larger than said first gap; and
flexible support elements connecting said sense mass to said drive mass.

14. An angular rate sensor as claimed in claim 13 wherein said each of said first and second regions includes a first surface and a second surface laterally displaced from said axis of rotation such that said first surface is interposed between said axis of rotation and said second surface, said first surface having a corrugation formed thereon, said first gap existing between said corrugation and said one of said frequency tuning electrodes, and said second gap existing between said second surface and said one of said sense electrodes.

15. An angular rate sensor as claimed in claim 13 wherein said axis of rotation is a first axis of rotation oriented parallel to said surface, said drive mass together with said sense mass are configured to move with said oscillatory motion about a second axis of rotation that is perpendicular to said surface, and said flexible support elements enable said sense mass to oscillate about said first axis of rotation in response to an angular velocity about a third axis of rotation that is perpendicular to each of said first and second axes of rotation.

16. An angular rate sensor as claimed in claim 13 further comprising force feedback electrodes fixedly mounted on said surface of said substrate, wherein for said each of said first and second regions, said first gap exists between said first portion of said sense mass and one of said force feedback electrodes.

17. An angular rate sensor as claimed in claim 13 further comprising quadrature compensation electrodes fixedly mounted on said surface of said substrate, wherein for said each of said first and second regions, said first gap exists between said first portion of said sense mass and one of said quadrature compensation electrodes.

18. An angular rate sensor as claimed in claim 13 wherein for said each of said first and second regions, said second gap exists between said second portion of said sense mass and a first portion of said sense electrode, and said first gap exists between said first portion of said sense mass and a second portion of said sense electrode.

19. An angular rate sensor comprising:
a substrate having a surface;
conductive plates fixedly mounted on said surface, said conductive plates including frequency tuning electrodes and sense electrodes;
a drive mass coupled to said substrate surface, said drive mass being configured to move with an oscillatory motion;
a sense mass having first and second regions separated by an axis of rotation, wherein each of said first and second regions includes a first surface and a second surface laterally displaced from said axis of rotation such that said first surface is interposed between said axis of rotation and said second surface, a first gap exists between said first surface and one of said frequency tuning electrodes, and a second gap exists between said second surface and one of said sense electrodes, said second gap being larger than said first gap; and
flexible support elements connecting said sense mass to said drive mass.

20. An angular rate sensor as claimed in claim 19 further comprising force feedback electrodes and quadrature compensation electrodes fixedly mounted to said surface of said substrate, said first gap existing between said first surface and one each of said force feedback electrodes and said quadrature compensation electrodes.
